(19) United States
(12) Patent Application Publication
(10) Pub. No.: US 2025/0261600 A1
(43) Pub. Date: Aug. 21, 2025

(54) MULTI-MODAL SYSTEM AND METHOD FOR REAL-TIME PLANT HYDRATION MONITORING AND IRRIGATION MANAGEMENT

(71) Applicant: Brad Wu, Chandler, AZ (US)

(72) Inventor: Brad Wu, Chandler, AZ (US)

(21) Appl. No.: 19/046,483

(22) Filed: Feb. 5, 2025

Related U.S. Application Data
(63) Continuation-in-part of application No. 18/582,975, filed on Feb. 21, 2024, now abandoned.

(51) Int. Cl. A01G 25/16; G06T 7/33

(52) U.S. Cl. CPC A01G 25/16; G06T 7/344; G06T 2207/10032; G06T 2207/20081; G06T 2207/30188

(57) ABSTRACT

The present invention discloses a multi-modal system for real-time plant hydration monitoring and irrigation management. The system comprises at least one acoustic sensor configured to emit controlled sound waves through plant tissues and detect corresponding vibrations and resonance frequencies using sensitive microphones or piezoelectric sensors to assess plant hydration. The system includes at least one bioelectrical sensor for monitoring bioelectrical signals. At least one nanotechnology-based sensor is configured to detect molecular changes in water content within plant cells through embedded or externally applied nanosensors. An aerial imaging device mounted on an unmanned aerial vehicle captures data related to canopy temperature, leaf color, and hydration indicators using infrared, multi-spectral, and thermal cameras. A central processing unit receives and analyzes data using predictive models, integrates the data via data fusion algorithm to generate a plant hydration profile, and controls water delivery through an irrigation management unit based on the hydration profile.

### CROSS REFERENCE

This application is a Continuation-in-Part (CIP) of U.S. Non-Provisional patent application Ser. No. 18/582,975, titled “A Machine Learning Device for Crop Water Optimization,” filed on Feb. 21, 2024, which claims priority to U.S. Provisional Patent Application No. 63/530,430, filed on Aug. 2, 2023. The entire contents of both applications are hereby incorporated by reference in their entirety.

### TECHNICAL FIELD

The present invention relates generally to agricultural technologies and, more specifically, to systems and methods for optimizing crop irrigation. This application extends prior technologies involving machine learning-based crop water optimization by incorporating multi-modal sensing technologies, including acoustic-based hydration detection, bioelectrical signal monitoring, nanotechnology-based hydration sensors, and drone-based hydration monitoring for real-time plant hydration assessment.

### BACKGROUND

Efficient management of water resources in agriculture is critical for sustainable farming practices, especially in regions affected by water scarcity. Traditional irrigation systems often rely on soil moisture sensors, manual observation, or environmental data, which fail to account for the dynamic physiological status of plants. While prior inventions introduced machine learning techniques to optimize irrigation based on growth stages and environmental conditions, they did not fully address plant hydration at the cellular or molecular level, nor did they integrate diverse data streams from advanced sensing technologies.

Therefore, there is a need for an advanced, comprehensive system that can provide real-time hydration data through multi-modal sensing technologies, enabling precise irrigation management to improve crop yield, reduce water waste, and adapt to diverse agricultural environments.

### BRIEF SUMMARY OF THE INVENTION

Accordingly, the present invention is a plant stage machine learning device for learning a plant stage and detecting the plant stage within a crop can comprise at least one sensor for measuring environmental parameters related to the plant stage. The device can have at least one camera configured to capture images of the plant stage. An observation unit can observe a variable obtained based on information from the at least one sensor and the at least one camera.

A learning unit can learn the plant stages based on detecting the information created from the at least one sensor and at least one camera based on training data created from the output of the observation unit and data related to detect the plant stage. The device can further have a watering mechanism.

The machine learning device can have at least one sensor wherein the at least one of a temperature sensor, a moisture sensor, a rain sensor, a humidity sensor, and volumetric moisture sensor. The machine learning device can further comprise training data wherein the data related to an image of the crop from the at least one camera which is the image of the actual crop at its various growth stages. The teacher data can be data related to a trained image of the crop which is an image of the crop in its different growth stages. The information about the plant stage can be germination, emergence, flow bud formation, early bloom, peak bloom, fruit formation, fruit development and harvest.

The water mechanism can be a water pump, water valve or irrigation valve that is remotely controlled by the machine learning device to allow or stop water to flow to the crop. The at least one sensor and at least one camera can be connected to a microcontroller having a wireless module wherein the wireless module sends and receives data from the machine learning device. The machine learning device can be on a cloud server or on a microcontroller unit. The at least one camera can be such as, for example, Wi-Fi enabled camera, ESP32-CAM, mini-camera, or digital camera. The at least one camera can capture an image of the crop at different periods of time between plant stage. The machine learning device can be connected to other machine learning devices that can control multiple crops. The machine learning device can comprise a neural network.

The method for managing water providing to a crop of individual plants includes capturing images of a plant at its different growth stages, analyzing the image and detecting the growth stage that the plant is in, training a learning unit to recognize the different growth stages of the plant wherein the learning unit recognizes the growth stage of the plant, and adjusting the water provided to the plant based on the growth stage of the plant. The learning unit receives data from at least one sensor and can determine a growth rate based on the growth stages of the plant over time and determine how much water is needed based on the growth rate and the current growth stage for that individual plant wherein the at least one sensor detects environmental conditions for the plant. The method can also include analyzing and controlling an irrigation system based on the captured images and environmental conditions. The machine learning device can learn the growth stage and environmental conditions for more than one type of plant.

In an aspect, the present invention relates to a multi-modal system for real-time plant hydration monitoring and irrigation management. The system may comprise at least one acoustic sensor configured to emit controlled sound waves through plant tissues and detect corresponding vibrations and resonance frequencies using sensitive microphones or piezoelectric sensors to assess plant hydration. Additionally, the system may include at least one bioelectrical sensor configured to monitor bioelectrical signals, including electrical conductivity and bioelectric potential variations within plant tissues, using embedded electrodes or non-invasive sensors.

In another aspect, the system may comprise at least one nanotechnology-based sensor configured to detect molecular changes in water content within plant cells by embedding or externally applying nanosensors. Furthermore, at least one aerial imaging device may be mounted on an unmanned aerial vehicle (UAV), where the aerial imaging device is configured to capture data related to canopy temperature, leaf color, and other hydration indicators using infrared, multi-spectral, and thermal cameras.

The system may further comprise a central processing unit (CPU) operatively connected to the acoustic sensor, bioelectrical sensor, nanotechnology-based sensor, and aerial imaging device. The CPU may be configured to receive data from each of these components and analyze the received data using predictive models trained on labeled datasets corresponding to hydration levels in different plant types. The CPU may integrate the analyzed data through a data fusion algorithm to generate a comprehensive plant hydration profile.

An irrigation management unit operatively connected to the CPU may control water delivery based on the generated plant hydration profile. The irrigation management unit may adjust water delivery through an automated irrigation valve based on hydration thresholds determined by the data fusion algorithm. Additionally, the irrigation management unit may generate alerts when plant hydration levels fall below predefined thresholds, indicating a need for manual intervention.

In another aspect, the invention provides a method for real-time plant hydration monitoring and irrigation management. The method may comprise the steps of detecting plant hydration-related characteristics using an acoustic sensor by emitting sound waves through plant tissue and measuring corresponding vibrations. The method may further include measuring bioelectrical properties of the plant using a bioelectrical sensor to detect variations in electrical conductivity or bioelectric potential, and sensing molecular water content within plant cells using a nanotechnology-based sensor.

The method may include capturing images of the plant canopy using an aerial imaging device configured to collect aerial imaging data, including thermal, infrared, or multi-spectral data. The collected data from the acoustic, bioelectrical, nanosensor, and aerial imaging devices may be transmitted to the central processing unit. The CPU may process and analyze the transmitted data using predictive models trained on labeled datasets corresponding to different plant hydration levels.

The method may further comprise integrating the analyzed data through a data fusion algorithm to determine the hydration status of the plant. Based on the determined hydration status, the method may control water delivery to the plant. The method may also include generating a hydration profile representing hydration levels across different plant growth stages and environmental conditions.

In an additional aspect, the method may involve comparing the collected data with reference data representing known hydration states of similar plant species. The data fusion algorithm may assign weighted values to different sensor outputs based on environmental conditions and plant species. The method may further comprise predicting future irrigation needs based on historical hydration data trends analyzed by the CPU and generating alerts when plant hydration levels fall below critical thresholds to indicate the need for immediate irrigation intervention.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

Other features and advantages of the invention will become apparent when reading the detailed description given below, purely by way of example and in a non-limitative manner, referring to the following figures:

FIG. 1 depicts a flow chart of a machine learning device for crop optimization in accordance to one, or more embodiments;

FIG. 2 depicts different plant stages in accordance to one, or more embodiments;

FIG. 3 depicts machine learning convolutional neural network to detect plant growth stages in accordance to one, or more embodiments;

FIG. 4 depicts neural network to train the dataset for the machine learning for crop optimization in accordance to one, or more embodiments;

FIG. 5 depicts image detection and machine learning object detection of a machine learning device in accordance to one, or more embodiments;

FIG. 6 depicts a low power solution for a machine learning device in accordance to one, or more embodiments;

FIG. 7 represents a block diagram of a multi-modal system for real-time plant hydration monitoring and irrigation management in accordance with the present invention; and

FIG. 8 shows a flow chart representing a method for real-time plant hydration monitoring and irrigation management.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

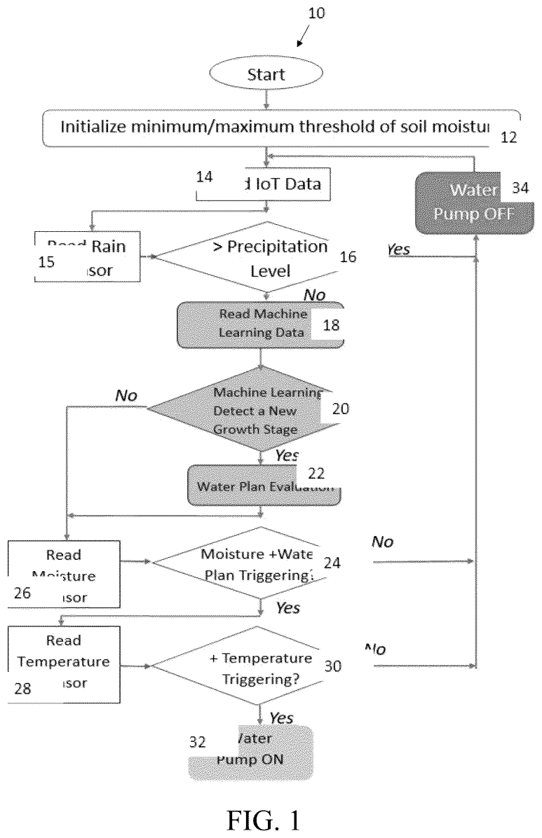

Referring initially to FIG. 1 which depicts a flow chart of a machine learning device for crop optimization shown generally at 10. A plant stage machine learning device for learning a plant stage and detecting the plant stage within a crop can comprise at least one sensor for measuring environmental parameters related to the plant stage wherein the at least one sensor can be at least one of such as, for example, a temperature sensor 28, a moisture sensor 26, a rain sensor 15, a humidity sensor, and volumetric moisture sensor. These sensors are designed to measure various environmental parameters that are critical to the growth and development of the plant. The temperature sensor 28 measures the ambient temperature in the vicinity of the plant, while the moisture sensor measures the moisture content in the soil where the plant is growing. The rain sensor 15 detects the presence of rainfall, and the humidity sensor measures the humidity level in the air. The volumetric moisture sensor 26 measures the volume of water in the soil, providing a more accurate assessment of the soil's water content.

The machine learning device can initialize and can detect the minimum or maximum threshold of the soil moisture 12 that the plant or crop is in, which can be determined by new reading from the at least one sensor or an old reading taken previously from the at least one sensor or user input for that particular plant type. The machine learning device can read the data 14 from the at least one sensor by such as, for example, wireless signal, long-range Wi-Fi, wired signal, cellular signal, satellite signal, or the like.

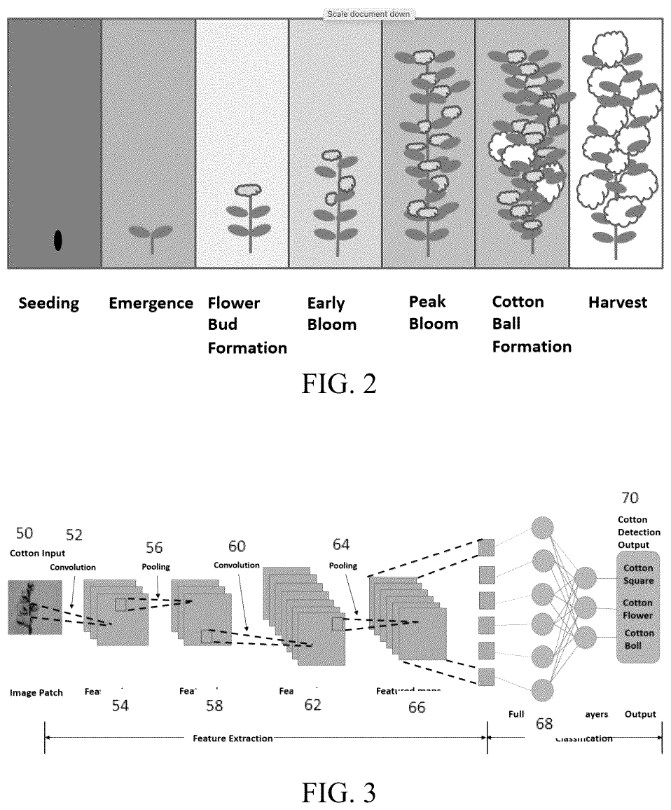

The machine learning device can have at least one camera configured to capture at least one image of the plant stages wherein the plant stages can be such as, for example, seeding, emergence, flow buds formation, early bloom, peak bloom, fruit formation/cotton ball formation, fruit development and harvest as shown in FIG. 2. Referencing FIG. 3, a machine learning device can be an observation unit which can observe a variable obtained based on information from the at least one sensor and/or the at least one camera. The observation unit can take an image patch 50 of the plant and convolute 52 the image from a past plant image crating a feature map 54. The feature maps can be pooled 56 together creating another feature map 58 and this process can be repeated 60, 62, 64, 66 to create a fully connected layer map 68 of the plant image over a period of time or over a certain instance creating training data creating a neural network architecture to detect plant growth. The fully connected layers 68 can output the plant stage and classify the plant in one of its stages and then the detection is outputted. For example, cotton detection output can be a cotton square, cotton flower, or cotton ball at 70.

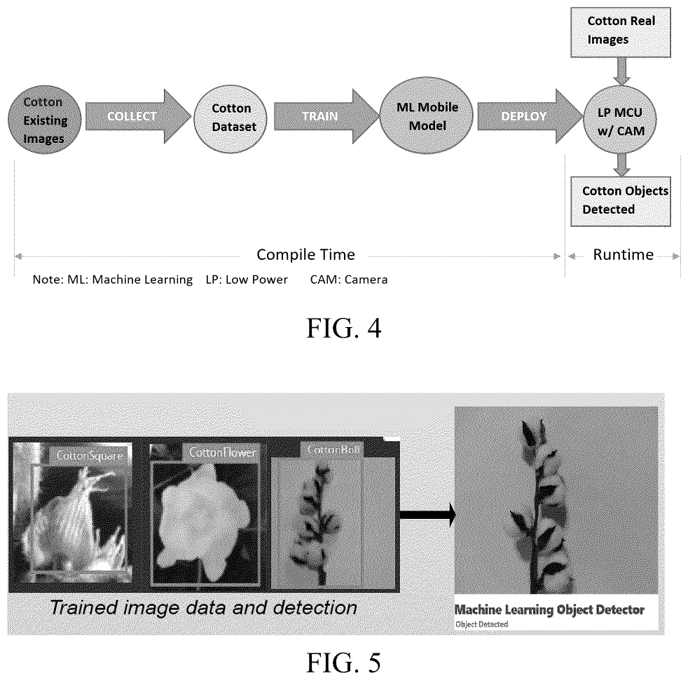

Referring to FIG. 4, the teacher data can be data or an example giving to the machine learning device that can learn and compare to related to a trained image of the crop which can be an image of the crop in its different growth stages. The teacher data can be information about the plant stage such as, for example, germination, leaf development, formation of side shoots, stem elongation, vegetative plant parts, inflorescence emergence, flowering, and fruit development.

The machine learning device can comprise a neural network. The machine learning device can have a compile time and a runtime wherein the compile time comprises taking the exiting cotton images, collecting the image and analyze that image dataset to a set of images at the different growth stages, and then train the ML mobile model and then deploy into the runtime wherein the runtime comprises looking at the plant's real images taken by the low powered MCU and comparing them with the plant's object detected by the low powered MCU with Camera. The machine learning device may be located on a cloud server or on a microcontroller unit. The cloud server provides the advantage of high computational power and large storage capacity, while the microcontroller unit provides the advantage of being located close to the plant, reducing the latency of data transmission. The machine learning device may further comprise a transceiver to network with at least one other machine learning device that controls at least one different crop. This allows for the sharing of data and learning between different machine learning devices, improving the overall performance of the system.

The training data can be the image of the crop from the at least one camera which is the image of the actual crop at its various growth stages. The training data can be taken at the various growth stages of the plant and can train the machine learning device to recognize the different growth stages as shown in FIG. 5. A learning unit can learn these plant stages based on detecting the information created from the at least one sensor and at least one camera which can be based on the training data created from the output of the observation unit and data related to detect the plant stage.

Referring back to FIG. 1, the machine learning device can further have a watering mechanism wherein the water mechanism can be turned on 32 or turned off 34 depending on the machine learning data and the data received from the at least one sensor. The water mechanism can be such as, for example, a water pump, water valve or irrigation valve which can be controlled by such as, for example, remotely, wired, or the like. The machine learning device can control the water mechanism controlling the amount of water that the crop or individual plant will see. Once the data is read 14, the rain sensor can be read and the precipitation level 16 is compared to the plant stage wherein the machine learning device reads the learning data 18 and compares it to the teacher data to see if the current plant is at a new growth stage 20 or at the same growth stage if it is then the water plan is evaluated and readjusted according to the plant stage and then adjusted according to the environmental conditions. For example, if the plant is at the same growth stage then the moisture level is read 26 and the moisture and watering plan is triggered 24 indicating that it potentially needs water wherein the temperature is then read 28. If each of these factors indicate that the plant or crop needs water then the device is trigger 30 and the watering mechanism is turned on 32, or if any factors indicate that the plant or crop is in the acceptable range then the watering mechanism remains off 34.

In embodiments, the at least one sensor and at least one camera can be connected to a microcontroller unit (“MCU”) having a wireless module wherein the wireless module can send and receive data from the machine learning device which can control and relay data from at least one of such as, for example, water mechanism, sensor, camera, or the like. In the preferred embodiment the machine learning device can be on a cloud server but in other embodiments it can be on an MCU. The at least one camera can be such as, for example, Wi-Fi enabled camera, ESP32-CAM, mini-camera, or digital camera. The at least one camera can capture an image of the crop at different periods of time between plant stage. The machine learning device can be connected to other machine learning devices and multiple MCUs that can control multiple crops or individual plant waterings.

In embodiments, a machine learning device method for detecting a plant stage can comprise capturing images of a plant at its different growth stages which it can then analyze using image patch, convolutions, featured maps, pooling and then connected the layer to get a output of the images which can then detect the growth stage that each plant is in. The method can further comprise training a learning unit to recognize the different growth stages of the plant wherein the learning unit can recognize such as, for example, germination, leaf development, formation of side shoots, stem elongation, vegetative plant parts, inflorescence emergence, flowering, and fruit development.

The machine learning device can adjust the water flow using the water mechanism to each crop or plant for the different growth stages. The learning unit can compare the at least one sensor with the growth rate to determine how much water is needed at the different growth stages for that particular plant wherein the sensors can detect the environmental conditions for the plant allowing the learning unit to analyze and adjust the watering for the plant stage and environmental condition. The machine learning device can comprise a method for analyzing and controlling the irrigation system based on the environmental conditions and captured images.

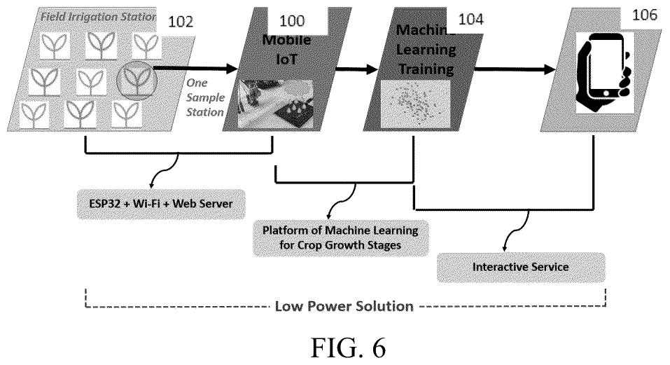

The machine learning device can learn the growth stage and environmental conditions for more than type of plant which can be such as, for example, cotton, soybeans, potatoes, corn, wheat, sugar beets, tomatoes, grapes, apples, lettuce, or the like and can adjust watering accordingly to each type of plant and its growth stage. FIG. 6 depicts a low power machine learning device wherein the device can comprise of a mobile internet of things device or low powered MCU 100 at a field irrigation station 102 wherein the internet of things device can be such as, for example a ESP32 module, or any suitable low powered MCU or the like having a wireless module which can be such as, for example, cellular module, Wi-Fi, Bluetooth, or the like that can be connected to a web server or cloud platform remotely. The cloud platform or web-based server can comprise the machine learning device for crop growth stages 104 wherein the internet of things device can communicate remotely to the machine learning device. The user can use a portable computing device 106 to be notified of the parameters of the machine learning device such as, plant growth stage, and environmental conditions.

The machine learning device can learn the growth stage and environmental conditions for more than one type of plant. This makes the device versatile and capable of managing a wide variety of crops. The machine learning device can be trained on different types of plants, allowing it to recognize the growth stages and water needs of each type of plant. This makes the device a powerful tool for managing water resources in a diverse agricultural setting.

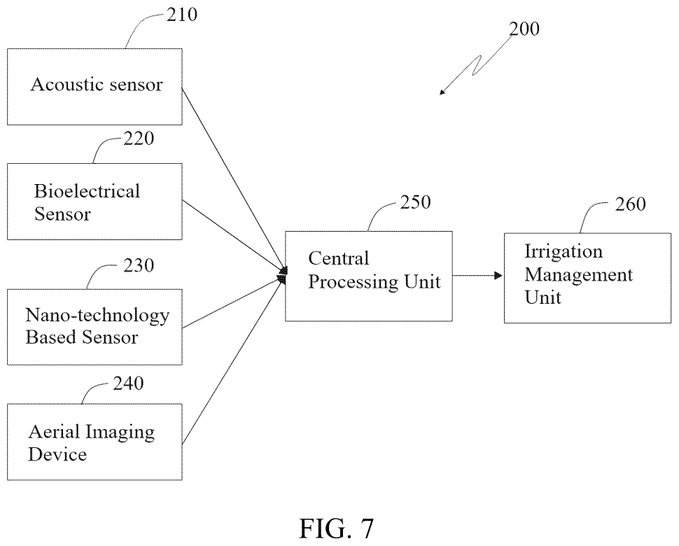

Referring now to FIG. 7, a block diagram of a multi-modal system 200 for real-time plant hydration monitoring and irrigation management in accordance with the present invention is provided. The multi-modal system 200 comprises a combination of sensors and processing units to collect, analyze, and integrate hydration-related data from plants. The multi-modal system 200 includes at least one acoustic sensor 210, at least one bioelectrical sensor 220, at least one nanotechnology-based sensor 230, at least one aerial imaging device 240, a central processing unit (CPU) 250 and an irrigation management unit 260.

The at least one acoustic sensor 210 is configured to emit controlled sound waves through plant tissues and detect corresponding vibrations and resonance frequencies. The acoustic sensor 210 may comprise a sound wave emitter and a detector, such as sensitive microphones or piezoelectric sensors, capable of capturing high-frequency vibrations.

For example, the acoustic sensor 210 may emit ultrasonic waves through a plant stem, and as these waves propagate through the tissue, they interact with the plant's internal structures. The variations in resonance frequencies are influenced by the plant's hydration status, as water content affects the plant's density and elasticity. The sensor detects these variations and transmits the acoustic data to the central processing unit 250 for analysis.

The CPU 250 analyzes the transmitted data to predict hydration status based on resonance frequency patterns. By comparing these patterns with reference datasets, the system can determine if the plant is under stress due to insufficient hydration.

The least one bioelectrical sensor 220 is configured to monitor bioelectrical signals, including electrical conductivity and bioelectric potential variations within plant tissues. This is achieved using embedded electrodes or non-invasive sensors placed on or near the plant.

For instance, electrodes can be attached to the stem or leaves of the plant to measure real-time changes in electrical conductivity. Variations in hydration levels cause changes in ion concentrations within plant tissues, which in turn affect bioelectrical signals. The bioelectrical sensor 220 transmits this data to the CPU 250, where it is processed to identify hydration-related patterns.

The CPU 250 processes these bioelectrical signals to detect trends indicative of water stress, enabling early intervention before visible signs of dehydration appear.

The at least one nanotechnology-based sensor 230 is configured to detect molecular changes in water content within plant cells. The nanosensors may be embedded directly into plant tissues or applied externally to the plant surface.

By way of non-limiting example, nanosensors composed of carbon nanotubes or fluorescent nanoparticles can be used to detect molecular hydration changes. These sensors may alter their electrical conductivity or optical properties (e.g., fluorescence) in response to water content variations. The nanosensor data is then transmitted to the CPU 250 for analysis to detect molecular-level hydration changes.

The CPU 250 processes the nanosensor data, identifying subtle variations that may not be detectable through traditional moisture sensors, thus allowing precise hydration monitoring at the cellular level.

The at least one aerial imaging device 240 is mounted on an unmanned aerial vehicle (UAV). This imaging device is configured to capture data related to plant hydration, including canopy temperature, leaf color, and stress indicators, using infrared, multi-spectral, and thermal cameras.

For example, a UAV equipped with a thermal camera may fly over an agricultural field to detect temperature differences in plant canopies. Elevated canopy temperatures may indicate water stress due to reduced transpiration. The captured images are transmitted to the CPU 250, which processes the data using an image analysis model to assess plant hydration status.

The CPU 250 may use an image recognition algorithm trained to detect hydration-related stress indicators, such as changes in leaf pigmentation, wilting patterns, or canopy temperature variations.

The central processing unit 250 is operatively connected to all the sensors and the aerial imaging device 240. The CPU 250 is configured to receive data from the acoustic, bioelectrical, nanotechnology-based sensors, and aerial imaging device 240. The CPU 250 analyze the received data using predictive models trained on labeled datasets corresponding to different plant hydration levels. Further, integrates the analyzed data through a data fusion algorithm to generate a plant hydration profile.

The data fusion algorithm combines multi-modal data, assigning weighted parameters to each data source based on factors such as sensor accuracy, environmental conditions, and plant species.

The system includes the irrigation management unit 260 operatively connected to the CPU 250. The irrigation management unit 260 is configured to control water delivery through automated irrigation valves based on hydration thresholds determined by the data fusion algorithm. The irrigation management unit 260 generate alerts when plant hydration levels fall below predefined thresholds, indicating a need for manual intervention. Further, adjust irrigation schedules automatically based on historical hydration trends and current hydration profiles.

For example, if the CPU detects a significant drop in hydration levels, the irrigation management unit 260 may activate an automated valve to deliver water to the affected plants. Conversely, if hydration levels are adequate, the system may delay irrigation, conserving water resources.

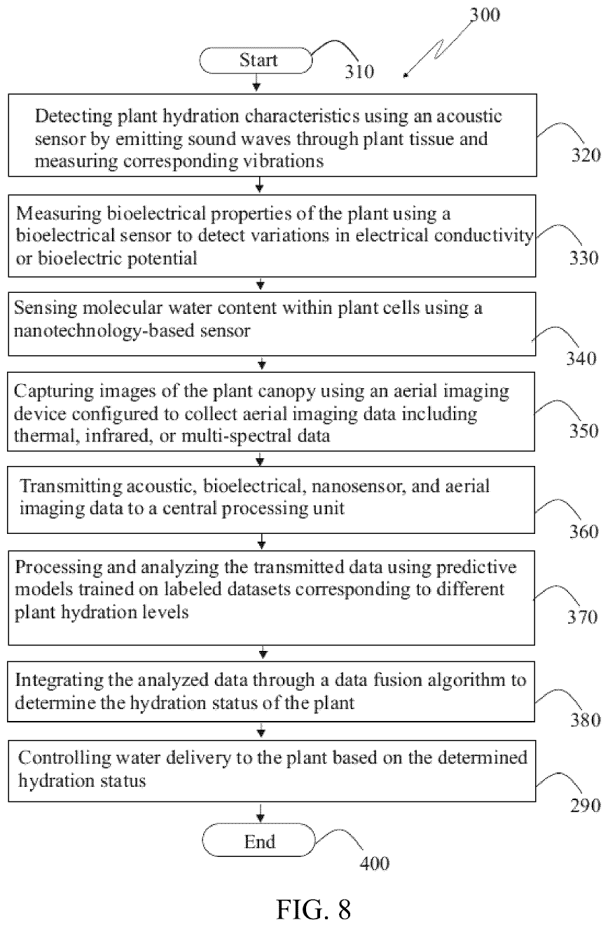

Referring now to FIG. 8, a method 310 for real-time plant hydration monitoring and irrigation management in accordance with the present invention is provided. The method is described in conjunction with the multi-modal system 200.

The method starts at step 310.

The step 320 involves detecting plant hydration-related characteristics using at least one acoustic sensor. The acoustic sensor operates by emitting controlled sound waves through plant tissues, such as the stem, leaf, or petiole. These sound waves may be in the ultrasonic or audible frequency range, depending on the specific plant species and environmental conditions.

The sound waves propagate through the plant tissue, interacting with its internal structures, including cell walls, xylem, and phloem. The interaction causes vibrations and resonance frequencies that are influenced by the plant's hydration status. A sensitive microphone or piezoelectric sensor is used to measure the vibrations and resonance frequencies as the sound waves travel through the tissue.

For example, in a cotton plant, an acoustic sensor may emit ultrasonic waves at frequencies between 20 kHz and 100 kHz. As the waves pass through the plant stem, the sensor detects changes in the resonance frequency, which vary based on the plant's water content. A hydrated stem will produce different resonance patterns compared to a dehydrated one due to changes in tissue elasticity and density.

The measured acoustic data is then transmitted to a central processing unit (CPU), where it is analyzed to determine hydration-related changes in the plant structure. The analysis compares the detected resonance frequencies with reference datasets corresponding to different hydration levels, allowing for accurate prediction of the plant's hydration status.

At step 330, measuring bioelectrical properties of the plant using at least one bioelectrical sensor. The bioelectrical sensor is configured to detect variations in electrical conductivity or bioelectric potential within the plant tissues.

The measurement process involves placing electrodes on or near the plant, typically on the stem, leaf, or root zone, depending on the plant species. The electrodes can be embedded directly into the tissue or applied externally using conductive gels or clips.

The bioelectrical sensor monitors real-time variations in electrical conductivity and bioelectric potential, which are influenced by the plant's water status. Changes in hydration levels alter ion concentrations within the plant's vascular system, affecting its electrical properties.

For example, in soybean plants, non-invasive electrodes can be clipped onto the leaves to measure changes in electrical conductivity. As the plant becomes dehydrated, the electrical resistance increases due to reduced ion mobility, indicating water stress.

The bioelectrical data is transmitted to the CPU, where it is processed to identify hydration-related patterns. The CPU analyzes the data to detect fluctuations in conductivity and potential, correlating them with the plant's hydration status.

Further at step 340, sensing molecular water content within plant cells using at least one nanotechnology-based sensor. These nanosensors can be embedded within plant tissues or applied externally to the plant surface, depending on the sensor design and the target crop.

Nanotechnology-based sensors are designed to detect molecular-level changes in water content by responding to variations in the plant's internal environment. These sensors may alter their optical properties (e.g., fluorescence) or electrical conductivity based on the presence of water molecules.

By way of non-limiting example, carbon nanotube-based nanosensors can be inserted into the leaf tissue of tomato plants. These sensors exhibit changes in fluorescence intensity when the surrounding water content fluctuates. Alternatively, graphene-based nanosensors may change their electrical conductivity in response to hydration changes at the cellular level.

The hydration data collected by the nanosensors is transmitted to the CPU, where it is processed to detect variations in water content. The CPU analyzes the nanosensor data alongside other sensor data to improve the accuracy of the hydration assessment.

At step 350, the method further includes capturing images of the plant canopy using an aerial imaging device mounted on an unmanned aerial vehicle (UAV). The imaging device is equipped with thermal, infrared, or multi-spectral cameras to collect data related to canopy temperature, leaf color, and other hydration indicators.

The UAV flies over agricultural fields along predefined flight paths to capture high-resolution images of the crop. Thermal cameras detect canopy temperature variations, which are linked to plant transpiration rates. Infrared and multi-spectral cameras capture data on leaf reflectance, which provides insights into plant health and hydration levels.

For example, in a vineyard, a UAV equipped with a multi-spectral camera may detect changes in the Normalized Difference Vegetation Index (NDVI), which indicates plant stress related to dehydration. Areas with lower NDVI values correspond to regions experiencing water stress.

The captured images are transmitted to the CPU, where they are processed using an image recognition model. The model identifies hydration stress indicators, such as color changes, wilting patterns, and temperature anomalies across large agricultural fields.

Further at step 360, all the collected data from the acoustic sensor, bioelectrical sensor, nanotechnology-based sensor, and aerial imaging device is transmitted to the central processing unit (CPU). The transmission can occur via wired connections in controlled environments like greenhouses or via wireless protocols (e.g., Wi-Fi, Bluetooth, or cellular networks) for large-scale agricultural fields.

The CPU functions as the central hub for data collection, aggregation, and processing. It receives real-time data streams from all the sensors and organizes them for further analysis.

At step 370, once the data is received, the CPU performs processing and analysis using predictive models trained on labeled datasets corresponding to different plant hydration levels. The predictive models may include statistical algorithms, pattern recognition techniques, and data classification models trained using historical plant data.

The analysis includes comparing the collected data with reference datasets that represent known hydration states for specific plant species. Identifying anomalies or patterns that suggest hydration stress. Correlating multi-modal data to improve the accuracy of the hydration status assessment.

For example, in maize crops, the CPU may compare current sensor data with historical data from previous growing seasons to identify early signs of drought stress.

At next step 380 integrating the analyzed data from all the sensors using a data fusion algorithm. The algorithm combines data from multiple sources to generate a comprehensive plant hydration profile. The data fusion process assigns weighted values to each sensor output based on factors such as sensor accuracy, environmental conditions, and plant species.

For example, during hot weather, the system may assign higher weight to thermal imaging data, as canopy temperature becomes a more significant hydration indicator under heat stress.

The hydration profile represents the plant's water status, providing insights into areas of water stress, optimal hydration zones, and irrigation needs.

Further at step 390, controlling Water Delivery Based on Hydration Status. Based on the hydration profile, the CPU communicates with an irrigation management unit to control water delivery to the plants. The irrigation system may include automated irrigation valves that regulate water flow, drip irrigation systems for targeted water delivery, and sprinkler systems for large-scale field coverage.

The irrigation management unit adjusts water delivery automatically based on predefined hydration thresholds. If the plant hydration profile indicates water stress, the system increases irrigation to the affected areas. Conversely, if the hydration levels are adequate, the system reduces or suspends irrigation to prevent overwatering.

The method further includes generating alerts when plant hydration levels fall below critical thresholds, indicating a need for immediate manual intervention. Alerts can be sent via SMS, mobile apps, or dashboard notifications to farm managers.

The method further includes predicting future irrigation requirements based on historical hydration data trends. The CPU analyzes past data to forecast potential water stress events, enabling proactive irrigation planning.

For example, in a citrus orchard, the system may predict a drought period based on historical temperature and soil moisture trends, allowing farmers to adjust irrigation schedules in advance.

The method 300 ends at step 400.

The foregoing descriptions of specific embodiments of the present invention have been presented for purposes of illustration and description. They are not intended to be exhaustive or to limit the present invention to the precise forms disclosed, and obviously, many modifications and variations are possible in light of the above teaching. The embodiments were chosen and described in order to explain the principles of the present invention best and its practical application, to thereby enable others skilled in the art to best utilise the present invention and various embodiments with various modifications as are suited to the particular use contemplated. It is understood that various omission and substitutions of equivalents are contemplated as circumstance may suggest or render expedient, but such are intended to cover the application or implementation without departing from the scope of the claims of the present invention.

We claim:

1. A method for managing water providing to a crop of individual plants, the method comprising the steps of:
capturing a first image patch of a plant;
capturing a second image patch of the plant and convoluting the second image patch with the first image patch to create a feature map of the plant;
capturing a plurality of subsequent image patches and convoluting the plurality of subsequent image patches with the feature map to create a layer map of the plant over a period of time
classifying the plant in a growth stage based on the layer map;
training a learning cloud server or microcontroller unit to recognize the different growth stages of the plant wherein the learning unit recognizes the growth stage of the plant; and
adjusting the water provided to the plant based on the growth stage of the plant.

2. The method as claimed in claim 1, wherein the learning cloud server or microcontroller unit receives data from at least one sensor and wherein the learning cloud server can determine a growth rate based on the growth stages of the plant over time and determine how much water is needed based on the growth rate and the current growth stage for that individual plant, and wherein the at least one sensor detects environmental conditions for the plant.

3. The method as claimed in claim 1, further comprising analyzing and controlling an irrigation system based on the captured images and environmental conditions.

4. The machine learning device according to claim 1, wherein the learning cloud server learns the growth stage and environmental conditions for more than one type of plant.

5. A multi-modal system for real-time plant hydration monitoring and irrigation management, the multi-modal system comprising:
at least one acoustic sensor configured to emit controlled sound waves through plant tissues and detect corresponding vibrations and resonance frequencies using sensitive microphones or piezoelectric sensors to assess plant hydration;
at least one bioelectrical sensor configured to monitor bioelectrical signals, including electrical conductivity and bioelectric potential variations within plant tissues, using embedded electrodes or non-invasive sensors;
at least one nanotechnology-based sensor configured to detect molecular changes in water content within plant cells by embedding or externally applying nanosensors;
at least one aerial imaging device mounted on an unmanned aerial vehicle, the least one aerial imaging device is configured to capture data related to canopy temperature, leaf color, and other hydration indicators using infrared, multi-spectral, and thermal cameras;
a central processing unit operatively connected to the acoustic sensor, bioelectrical sensor, nanotechnology-based sensor, and aerial imaging device, the central processing unit configured to:
receive data from each of the sensors and the aerial imaging device;
analyze the received data using predictive models trained on labeled datasets corresponding to hydration levels in different plant types;
integrate the analyzed data through a data fusion algorithm to generate a plant hydration profile; and
an irrigation management unit operatively connected to the central processing unit, the irrigation management unit configured to control water delivery based on the plant hydration profile.

6. The multi-modal system as claimed in claim 5, wherein the acoustic sensor is configured to detect acoustic data, transmit the data to the central processing unit, and the central processing unit analyzes the transmitted data to predict hydration status based on resonance frequency patterns.

7. The multi-modal system as claimed in claim 5, wherein the bioelectrical sensor transmits real-time bioelectrical data to the central processing unit, which processes the data to identify hydration-related patterns.

8. The multi-modal system as claimed in claim 5, wherein the nanotechnology-based sensor transmits data related to molecular-level hydration changes to the central processing unit for analysis to detect variations in water content.

9. The multi-modal system as claimed in claim 5, wherein the images captured by the aerial imaging device are transmitted to the central processing unit, which processes the data using an image analysis model to assess plant hydration status.

10. The multi-modal system as claimed in claim 9, wherein the central processing unit is configured to process the data using an image recognition algorithm trained to detect hydration-related stress indicators in plants.

11. The multi-modal system as claimed in claim 5, wherein the data fusion algorithm generates the plant hydration profile by integrating data from the acoustic sensor, bioelectrical sensor, nanotechnology-based sensor, and aerial imaging device, with weighted parameters assigned based on sensor accuracy and environmental conditions.

12. The multi-modal system as claimed in claim 5, wherein the irrigation management unit adjusts water delivery through an automated irrigation valve based on hydration thresholds determined by the data fusion algorithm.

13. The multi-modal system as claimed in claim 5, wherein the central processing unit is configured to detect trends in plant hydration over time to predict future irrigation requirements.

14. The multi-modal system as claimed in claim 5, wherein the irrigation management unit generates alerts when plant hydration levels fall below predefined thresholds, indicating a need for manual intervention.

15. A method for real-time plant hydration monitoring and irrigation management, the method comprising the steps of:
detecting plant hydration-related characteristics using an acoustic sensor by emitting sound waves through plant tissue and measuring corresponding vibrations;
measuring bioelectrical properties of the plant using a bioelectrical sensor to detect variations in electrical conductivity or bioelectric potential;
sensing molecular water content within plant cells using a nanotechnology-based sensor;
capturing images of the plant canopy using an aerial imaging device configured to collect aerial imaging data including thermal, infrared, or multi-spectral data;
transmitting acoustic, bioelectrical, nanosensor, and aerial imaging data to a central processing unit;
processing and analyzing the transmitted data using predictive models trained on labeled datasets corresponding to different plant hydration levels;
integrating the analyzed data through a data fusion algorithm to determine the hydration status of the plant; and
controlling water delivery to the plant based on the determined hydration status.

16. The method as claimed in claim 15, wherein detecting plant hydration using the acoustic sensor comprises the steps of:
emitting controlled sound waves through plant tissue;
measuring the vibrations and resonance frequencies produced as the sound waves propagate through the plant tissue; and
analyzing the measured data to determine hydration-related changes in the plant structure.

17. The method as claimed in claim 15, wherein measuring bioelectrical properties of the plant comprises the steps of:
placing electrodes on or near the plant to monitor electrical conductivity or bioelectric potential;
detecting variations in the bioelectrical signals corresponding to changes in plant hydration; and
analyzing the detected variations to determine the plant's hydration status.

18. The method as claimed in claim 15, wherein sensing molecular water content within plant cells comprises the steps of:
embedding or applying nanotechnology-based sensors to the plant;
detecting molecular-level changes in water content within plant cells through changes in optical or electrical properties of the sensors; and
processing the detected changes to determine the hydration status of the plant.

19. The method as claimed in claim 15, wherein capturing images of the plant canopy comprises using an aerial imaging device mounted on an unmanned aerial vehicle to capture thermal, infrared, or multi-spectral images of the plant wherein the captured images are processed using an image recognition model to identify hydration stress across large agricultural fields.

20. The method as claimed in claim 15, wherein processing and analyzing data comprises comparing the collected data with reference data representing known hydration states of similar plant species.

21. The method as claimed in claim 15, wherein integrating data through the data fusion algorithm comprises assigning weighted values to different sensor outputs based on environmental conditions and plant species.

22. The method as claimed in claim 15, further comprising generating a hydration profile based on integrated data from multiple sensors, wherein the hydration profile represents hydration levels across different plant growth stages and environmental conditions.

23. The method as claimed in claim 15, wherein controlling water delivery comprises adjusting irrigation schedules automatically based on hydration thresholds determined by the integrated hydration data.

24. The method as claimed in claim 15, further comprising generating alerts when plant hydration levels fall below a critical threshold, indicating the need for immediate irrigation intervention.

25. The method as claimed in claim 15, further comprising predicting future irrigation needs based on historical hydration data trends analyzed by the central processing unit.
